(19) United States
(12) Patent Application Publication
(10) Pub. No.: US 2011/0243125 A1
(43) Pub. Date: Oct. 6, 2011

(54) COMMUNICATION USING A USER TERMINAL

(75) Inventors: Madis Kaal, Tallinn (EE); Henn Ruukel, Tabasalu (EE)

(73) Assignee: Skype Limited, Dublin (IE)

(21) Appl. No.: 12/824,681

(22) Filed: Jun. 28, 2010

(30) Foreign Application Priority Data
Mar. 31, 2010 (GB) 1005386.6

(51) Int. Cl. H04L 12/66; H04W 4/00

(52) U.S. Cl. 370/352; 455/426.1

(57) ABSTRACT

Provided is a method of communicating using a user terminal that comprises: a first interface for exchanging call data with a first interface of a mobile communication device, wherein the mobile communication device comprises a second interface for interfacing with a node of a mobile telecommunications network, and wherein the first interface of the mobile communication device is unsuitable for interfacing with a node of a mobile telecommunications network; a second interface for exchanging call data with a second user terminal over a packet-based communication network; and a processor for executing a communications client, which processor is coupled to the first interface of the user terminal and to the second interface of the user terminal and is configured to participate in a call with the second user terminal via the second interface of the user terminal and the packet-based communication network; wherein the method comprises: sending call data via one of the first interface of the user terminal and the second interface of the user terminal during the call, on the basis of call data received via the other of the first interface of the user terminal and the second interface of the user terminal.

### RELATED APPLICATION

This application claims priority under 35 U.S.C. §119 or 365 to Great Britain Application No. 1005386.6, filed Mar. 31, 2010. The entire teachings of the above application are incorporated herein by reference.

### TECHNICAL FIELD

The present invention relates to a method of operating a user terminal, and more specifically to a method of communicating using a user terminal. It also relates to a computer program product for operation of a user terminal by implementing the method and to the user terminal itself.

### BACKGROUND

Some communication systems allow the user of a communication device, such as a personal computer, to communicate across a packet-based computer network, such as the Internet. Such communication systems include voice over internet protocol (“VoIP”) systems. These systems are beneficial to the user as they are often of significantly lower cost than conventional fixed line or mobile telecommunication networks. This may particularly be the case for long-distance communication. To use a VoIP system, the user installs and executes client software on their device. The client software sets up the VoIP connections as well as providing other functions such as registration and authentication. In addition to voice communication, the client may also set up connections for other communication media such as video calling, instant messaging (“IM”), SMS messaging, file transfer and voicemail.

One type of communication system for packet-based communication uses a peer-to-peer (“P2P”) topology. To enable access to a peer-to-peer system, a user must execute P2P client software provided by a P2P software provider on their computer, and register with the P2P system. When the user registers with the P2P system, the client software is provided with a digital certificate from a server. Once the client software has been provided with the certificate, then calls or other communication connections can subsequently be set up and routed between users of the P2P system without the further use of a server in the set-up. Instead, the client looks up the required IP addresses from information distributed amongst the P2P client software on other end users' computers within the P2P system. That is, the address look-up list is distributed amongst the peers themselves. Once the IP address of a callee's terminal has thus been determined, the caller's P2P client software then exchanges certificates with the callee's P2P client software. The exchange of the digital certificates (or user identity certificates, “UIC”) between users provides proof of the users' identities and that they are suitably authorised and authenticated in the P2P system. Therefore, the presentation of digital certificates provides trust in the identity of the users.

It is therefore a characteristic of peer-to-peer communication that, once registered, the users can set up their own communication routes through the P2P system in an at least partially decentralized manner based on distributed address look-up and/or the exchange of one or more digital certificates, without using a server for those purposes. Further details of an example P2P system can be found in WO 2005/009019.

VoIP or other packet-based communications can also be implemented using non-P2P systems that do use centralized call set-up and/or authentication, e.g. via a server or mobile telecommunications network.

Alternatively to running the client software on a personal computer, it is also known to run the client software on a mobile communication device, such as a mobile phone. The user may use the infrastructure of the device itself as an interface for interaction with the software running on the device. Alternatively, the user may connect to the mobile communication device a headset to act as an audio input/output device for interaction with the software running on the device. The mobile communication device thus then acts as a master for the connected headset, and communicates with another party using VoIP via the mobile telecommunications network.

However, VoIP applications can be resource-hungry, which drives up mobile communication device hardware and software costs. Furthermore, running a VoIP application on a mobile communication device can quickly deplete the battery of the device, thus requiring the user to recharge the battery on a more regular basis.

It is an aim of some embodiments of the present invention to address one or more of these problems.

### SUMMARY

Accordingly, according to a first aspect of the present invention, there may be provided a method of communicating using a user terminal that comprises: a first interface for exchanging call data with a first interface of a mobile communication device, wherein the mobile communication device comprises a second interface for interfacing with a node of a mobile telecommunications network, and wherein the first interface of the mobile communication device is unsuitable for interfacing with a node of a mobile telecommunications network; a second interface for exchanging call data with a second user terminal over a packet-based communication network; and a processor for executing a communications client, which processor is coupled to the first interface of the user terminal and to the second interface of the user terminal and is configured to participate in a call with the second user terminal via the second interface of the user terminal and the packet-based communication network; wherein the method comprises: sending call data via one of the first interface of the user terminal and the second interface of the user terminal during the call, on the basis of call data received via the other of the first interface of the user terminal and the second interface of the user terminal.

In embodiments, the method may comprise sending to the second user terminal a request to set up the call, in dependence on receiving from the mobile communication device a request to set up the call. The request to set up the call from the mobile communication device may comprise an indication of an identity of the second user terminal.

The method may comprise sending a signal to the mobile communication device, to cause the mobile communication device to be activated as an input/output device for interaction with the processor during the call. Preferably the user terminal comprises a personal computer having a microphone and a speaker, and the method comprises causing activation of the microphone and the speaker as audio input/output devices for interaction with the processor during the call, in dependence on a determination that the mobile communication device is to cease acting as an input/output device for interaction with the processor. The determination may comprise one of a determination that the mobile communication device has been switched off and a determination that a battery of the mobile communication device has dropped below a threshold level of charge.

The causing of the activation of the microphone and the speaker may be in dependence on receiving an instruction to cause the activation of the microphone and the speaker, such as an instruction from the mobile communication device.

The method may comprise sending a notification signal to the mobile communication device to cause the mobile communication device to provide to a user a notification of an incoming call, in dependence on receiving an indication of the incoming call via the first interface. The notification signal may comprise an indication of an identity of the second user terminal. Preferably the user terminal comprises a personal computer. Preferably the method comprises causing the personal computer to also provide to a user a notification of the incoming call.

Preferably the user terminal comprises at least one interface for communication with at least one other communication device.

The method may comprise causing one of the at least one other communication devices to be activated as an input/output device for interaction with the processor during the call, in dependence on receiving an instruction to make said one of the at least one other communication devices an input/output device for the call. The instruction may be from the mobile communication device. The method may comprise sending a respective notification signal to each of the at least one other communication devices to cause each of the at least one other communication devices to provide a notification to a user of an incoming call, in dependence on receiving an indication of the incoming call via the first interface.

In some scenarios, call data may be sent to the mobile communication device and each of the at least one other communication devices during the call with the second user terminal.

The method may comprise causing the mobile communication device to be activated as an input/output device for interaction with the processor during the call and causing the at least one other communication device to not be activated as an input/output device for interaction with the processor during the call, in dependence on receiving an instruction to cause the mobile communication device to be activated as an input/output device for interaction with the processor, such as an instruction from the mobile communication device.

Preferably the first user terminal is connected to the mobile communication device via a Bluetooth connection. Preferably the packet-based communication network comprises the internet and the communications client comprises one or both of a voice over internet protocol client and a video over internet protocol client.

According to a second aspect of the present invention, there may be provided a method of communicating using a mobile communication device that comprises: a first interface for exchanging call data with a user terminal connected to a packet-based communication network during a call, which first interface is unsuitable for interfacing with a node of a mobile telecommunications network; a second interface for interfacing with a node of a mobile telecommunications network; a microphone for receiving sound; a speaker for outputting sound; and a processor coupled to the first interface, to the microphone and to the speaker; wherein the method comprises: the processor sending call data via the first interface during the call, on the basis of sound received at the microphone; and the processor causing sound to be output from the speaker during the call, on the basis of call data received via the first interface.

A third aspect of the present invention may provide a computer program product for communicating using a user terminal, the program comprising code embodied on a computer-readable medium arranged so as, when executed on a processor, to implement the method of the first aspect of the present invention. The method may comprise steps in accordance with any of the above-mentioned method features of the first aspect.

A fourth aspect of the present invention may provide a computer program product for communicating using a mobile communication device, the program comprising code embodied on a computer-readable medium arranged so as, when executed on a processor, to implement the method of the second aspect of the present invention.

A fifth aspect of the present invention may provide a user terminal, comprising: a first interface for exchanging call data with a first interface of a mobile communication device, wherein the mobile communication device comprises a second interface for interfacing with a node of a mobile telecommunications network, and wherein the first interface of the mobile communication device is unsuitable for interfacing with a node of a mobile telecommunications network; a second interface for exchanging call data with a second user terminal over a packet-based communication network; and a processor for executing a communications client, which processor is coupled to the first interface of the user terminal and to the second interface of the user terminal and is configured to participate in a call with the second user terminal via the second interface of the user terminal and the packet-based communication network; wherein the processor is configured, during the call, to send call data via one of the first interface of the user terminal and the second interface of the user terminal, on the basis of call data received via the other of the first interface of the user terminal and the second interface of the user terminal. The user terminal may be configured in accordance with any of the above-mentioned method features of the first aspect.

A sixth aspect of the present invention may provide a mobile communication device, comprising: a first interface for exchanging call data with a user terminal connected to a packet-based communication network during a call, which first interface is unsuitable for interfacing with a node of a mobile telecommunications network; a second interface for interfacing with a node of a mobile telecommunications network; a microphone for receiving sound; a speaker for outputting sound; and a processor coupled to the first interface, to the microphone and to the speaker; wherein the processor is configured, during the call, to send call data via the first interface, on the basis of sound received at the microphone, and to cause sound to be output from the speaker, on the basis of call data received via the first interface.

### BRIEF DESCRIPTION OF THE DRAWINGS

For a better understanding of the present invention and to show how it may be carried into effect, reference will now be made by way of example to the accompanying drawings in which:

FIG. 1 is a schematic representation of a packet-based network such as the Internet;

FIG. 2 is a schematic block diagram of a user terminal installed with a P2P communications client, according to embodiments of the present invention;

FIG. 3 is a schematic representation of a P2P communications client user interface viewed on a user terminal;

FIG. 4 is a schematic representation of connections between the user terminal of a first embodiment of the present invention, a mobile communication device, and a packet-based network;

FIG. 5 is a schematic representation of connections between the user terminal of a second embodiment of the present invention, plural mobile communication devices, and a packet-based network;

FIG. 6 is a flow chart showing a method according to an embodiment of the present invention; and

FIG. 7 is a flow chart showing a method according to another embodiment of the present invention.

### DETAILED DESCRIPTION

As discussed above, VoIP applications can be resource-hungry when run on a mobile communication device, such as a mobile phone, which drives up mobile communication device hardware and software costs. Running a VoIP application on a mobile communication device can also quickly deplete the battery of the mobile communication device. Both of these problems are avoided if the VoIP application itself does not have to be running on the mobile communication device.

As also discussed above, a personal computer can be used to communicate across a packet-based computer network using a VoIP system. A handset or headset could be connected to the personal computer as an audio interface, i.e. as an audio input/output device. Although a headset permits a user to keep their hands free for carrying out other tasks, they would offer no or very limited functionality for the user to interact with the client software on the personal computer. Thus, the user still has to remain close to the personal computer in order to further interact with the software using a keyboard and/or mouse connected to the personal computer.

In preferred embodiments of the present invention, a Bluetooth-equipped mobile communication device, such as a mobile phone, is paired to a computer, such as a personal computer. This switches the role of the mobile communication device, normally acting as a master for a connected headset, into a slave for the computer, adding several significant new possibilities to leverage existing technologies.

One important advantage of using a mobile communication device, such as a mobile phone, is that users usually already have the mobile communication device, meaning no additional device needs to be purchased, carried, and recharged. Moreover, there is a clear benefit of being able to use an existing mobile communication device to place cheaper calls using VoIP technology, as the user will be familiar with the mobile communication device. The VoIP functionality can be integrated into the mobile communication device with very little impact on resource usage, and there is no additional power consumption when the mobile communication device is outside of the coverage area of the wireless network.

Furthermore, since the mobile communication device has an air interface with a mobile telecommunications network and another, different interface with the user terminal (which user terminal is connected to the internet or other packet-based computer network), the mobile communication device can be used to make calls over either or both of the mobile telecommunications network and the packet-based computer network.

In some embodiments, the mobile communication device can use stored (or otherwise accessible) contact details in order to establish a call with a callee via the mobile telecommunications network. For each potential callee, the contact details may comprise an identity of the callee that is recognisable in the mobile telecommunications network.

In some embodiments, for at least some of those callees, the contact details may comprise an identity of the callee that is recognisable in another network, such as a packet-based computer network (e.g. the Internet). In some embodiments, the mobile communication device is able to establish a call with a callee via the packet-based computer network using contact details of that callee that are usable also in the mobile telecommunications network.

In some embodiments the mobile communication device rings when there is an incoming VoIP call, allowing the user to pick up the call directly from the mobile communication device, which would then become an active input/output audio device for the VoIP application while the user terminal remains as the end point of the call. In some embodiments, multiple communication devices are paired with a computer at the same time, and in this case all of them may ring, and the one from where the call is picked up becomes an active input/output audio device while the user terminal remains as the end point of the call.

The computer on which the communications client runs may comprise a dedicated base station.

When paired to a computer running a VoIP application, the mobile communication device may offer a “call using VoIP” choice in its address book. Selection of this choice would instruct the communications client application running on the computer to place a call to a PSTN number or VoIP username, and also activate the mobile communication device as an input/output audio device.

If the mobile communication device is identifiable as supporting the required functionality, in some embodiments the communications client application running on the computer may offer explicit support for this device, most importantly ringing the mobile communication device on incoming calls in parallel with causing an incoming call indication to be provided by the computer, and activating the mobile communication device as an input/output audio device if the user chooses to place or receive a call.

With embodiments of the present invention, the user of the mobile communication device does not need an additional device (headset or handset) if the computer, for example, does not include a microphone, or if wired hands-free operation would be a distraction to surrounding people or would be a privacy concern for the user. Some embodiments of the present invention enable a user to answer the mobile communication device, and even move around within Bluetooth coverage without being tethered to the computer. There would also be no need to worry about another device that needs charging.

As the computer is the endpoint of the VoIP call, even if the mobile communication device's battery runs out, in some embodiments the communications client application on the computer may just switch audio to internal speakers and microphone without the call being dropped.

In some embodiments, the mobile communication device has a functionality to initiate an input/output audio device switch, basically changing the input/output audio device for the call to another device connected to, or paired with, the computer, such as another mobile communication device, a call recording device, or a television set.

In some embodiments, no VoIP software needs to be run on the mobile communication device. Some embodiments of the present invention may be applied to any VoIP application running on a personal computer. A standardised Bluetooth VoIP handset profile may be created.

Aside from Bluetooth, a similar approach could be used with different network technologies, most notably wireless fidelity (WiFi) and wireless USB, which can offer greater range than Bluetooth at some cost of higher power consumption.

Examples of a suitable communication system and communications client for the implementation of embodiments of the invention will now be described.

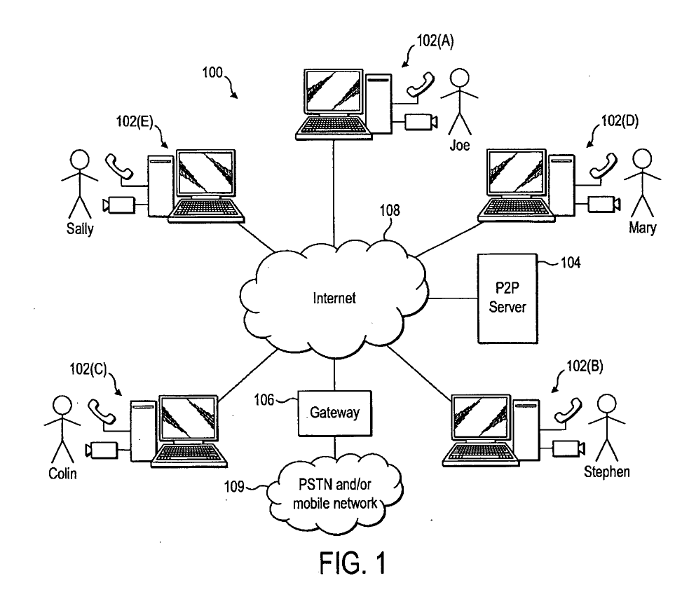

FIG. 1 is a schematic illustration of a packet-based network such as the Internet, to which are coupled a plurality of interconnected elements such as those labelled 102, 104 and 106. Each network element is inter-coupled with the rest of the Internet 108, and is configured to communicate data with other such elements over the Internet by transmitting and receiving data in the form of Internet Protocol (IP) packets. Each element also has an associated IP address usable in the Internet to locate the element. The elements shown explicitly in FIG. 1 are: a plurality of end-user terminals 102(A) to 102(E), such as desktop or laptop PCs or Internet-enabled mobile communication devices (such as mobile phones); one or more P2P servers 104; and a gateway 106 to another type of network 109 such as to a traditional Public-Switched Telephone Network (PSTN) or other circuit switched network, and/or to a mobile telecommunications network, such as a mobile cellular network. However, it will of course be appreciated that many more elements make up the Internet than those explicitly shown. This is represented schematically in FIG. 1 by a communications cloud 108 which will include many end-user terminals, servers and gateways, as well as routers of Internet service providers (ISPs) and Internet backbone routers.

Each of a plurality of the end-user terminals 102 is installed with communication software in the form of a P2P communications client application. When executed, this allows the end-user terminals 102 to establish bidirectional communication channels with other such end-user terminals 102 via the Internet using P2P call set-up (or more generally connection set-up). The P2P communications clients also share presence information with one another, which provides an availability status of users. The presence information for each user is preferably at least in part defined by the user themselves. To supplement the decentralized call set-up, the P2P communications client may retrieve some additional information from the P2P server 104, such as contact lists which provide the names and user IDs of the users' contacts, and “avatars” which are images chosen by users to represent themselves within the P2P system.

There may also be a P2P communications client installed at one or more gateways 106 coupled to both the Internet 108 and one or more other networks 109 such as a PSTN network and/or a mobile telecommunications network. This allows the P2P communications clients running on end-user terminals 102 to communicate with ordinary land-line telephones and/or mobile telephones (or other mobile telecommunication devices) respectively, even if those telephones themselves do not run P2P communications clients and are not directly coupled to the Internet. In that case, the P2P communications client on the terminal 102 sets up a connection over the Internet with the P2P communications client on the gateway 106 using P2P call set-up and provides it with a phone number, and the gateway 106 uses the phone number to set up a connection with the telephone over the respective other PSTN or mobile telecommunications network. Or in the other direction, a telephone user in one of the PSTN or mobile telecommunications network may dial into the gateway 106 with a number that identifies the user within the P2P system, and the gateway 106 will set up a connection with that user's terminal 102 over the Internet. In either case, a bidirectional communication channel can thus be established via the Internet and PSTN or mobile telecommunications network.

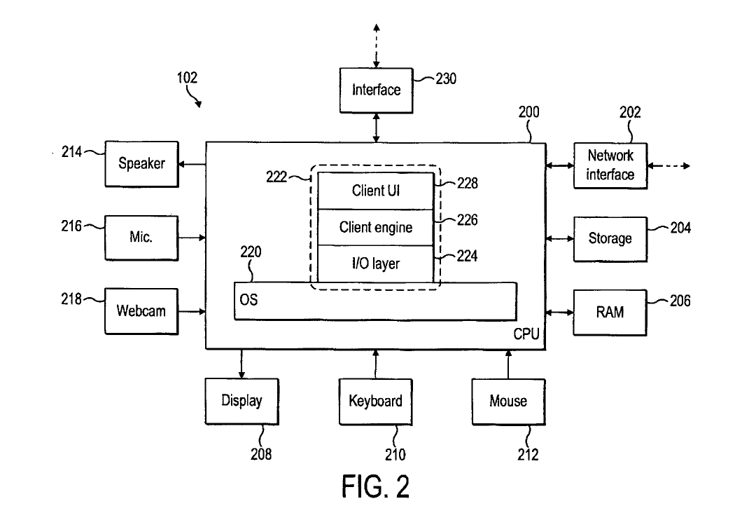

The schematic block diagram of FIG. 2 shows an example of an end-user terminal 102 that is configured to act as a terminal of a P2P system operating over the Internet, according to embodiments of the present invention. The user terminal 102 comprises a processor or CPU 200 operatively coupled to: a network interface 202 such as modem for connecting to the Internet 108, a non-volatile storage device 204 such as a hard-drive or flash memory, and a volatile memory device such as a random access memory (RAM) 206. The user terminal 102 also comprises one or more user input devices, for example in the form of a keyboard or keypad 210, a mouse 212, a microphone 216 and a webcam 218, each operatively coupled to the CPU 200. The terminal 102 further comprises one or more user output devices, for example in the form of a display screen 208 and speaker 214, again each operatively coupled to the CPU 200. The user terminal 102 further comprises an interface 230 for establishing a wireless connection with a mobile phone. In other embodiments, as discussed below, the interface 230 can be for establishing a wired connection, and in some embodiments the connection can be with a mobile communication device other than a mobile phone.

The storage device 204 stores software including at least an operating system (OS) 220, and packet-based communication software in the form of a P2P communications client 222. On start-up or reset of the terminal 102, the operating system software 220 is automatically loaded into the RAM 206 and from there is run by being executed on the CPU 200. Once running, the operating system 220 can then run applications such as the P2P communications client 222 by loading them into the into the RAM 206 and executing them on the CPU 200. To represent this schematically in FIG. 2, the operating system 220 and P2P communications client 222 are shown within the CPU 200.

The P2P communications client 222 comprises a “stack” having three basic layers: an input and output (I/O) layer 224, a client engine layer 226, and a user interface (UI) layer 228. Each layer is responsible for specific functions. Because each successive layer usually communicates with two adjacent layers (or one in the case of the top layer), they are regarded as being arranged in a stack as shown in FIG. 2. The P2P communications client 222 is said to be run “on” the operating system 220. This means that in a multi-tasking environment it is scheduled for execution by the operating system 220, and further that inputs to the lowest (I/O) layer 224 of the P2P communications client 222 from the input devices 202, 216, 218 and 230 as well as outputs from the I/O layer 224 to the output devices 202, 208, 214 and 230 may be mediated via suitable drivers and/or APIs of the operating system 220.

The I/O layer 224 of the P2P communications client comprises a voice engine and optionally a video engine in the form of audio and video codecs which receive incoming encoded streams and decode them for output to speaker 214 and/or display 208 and/or interface 230 as appropriate, and which receive unencoded audio and/or video information from the microphone 216 and/or webcam 218 and/or interface 230 and encode them for transmission as streams to other end-user terminals 102 of the P2P system. The I/O layer 224 may also comprises a control signaling protocol for signaling control information between terminals 102 of the network.

The client engine 226 then handles the connection management functions of the P2P system as discussed above, such as establishing calls or other connections by P2P address look-up and authentication. The client engine 226 may also be responsible for other secondary functions of the P2P system, such as supplying up-to-date contact lists and/or avatar images of the user to the P2P server 104, or retrieving up-to-date contact lists of the user and retrieving up-to-date avatar images of other users from the P2P server 104. Further, the client engine 226 may retrieve presence information from the other clients of the users in the contact list by periodically polling them via a public API, and reciprocally provide its own presence information when polled by those other clients that are online. Exchange of presence information directly between clients via a public API is the preferred option, but alternatively the presence information could be exchanged via an intermediate node such as a server 104.

The UI layer 228 is responsible for presenting decoded video to the user via the display 208, for presenting the output on the display 208 along with other information such as presence and profile information and user controls such as buttons and menus, and for receiving inputs from the user via the presented controls.

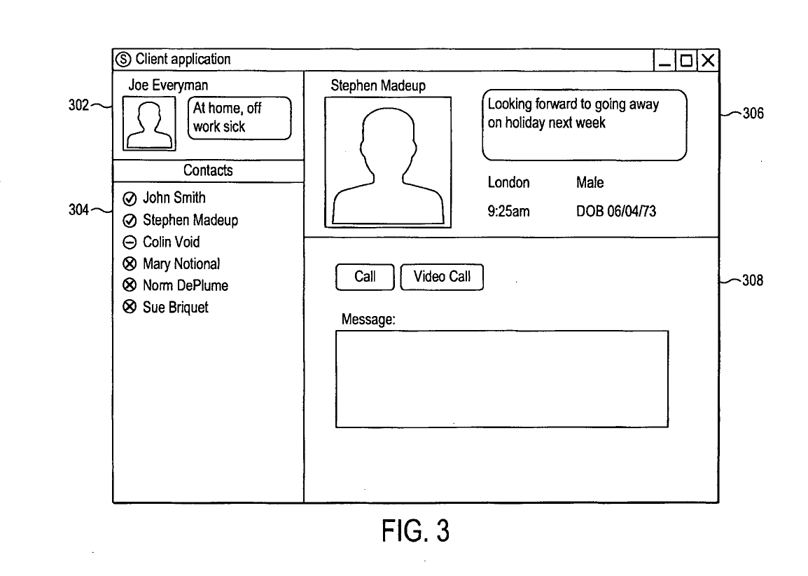

FIG. 3 illustrates schematically an example user interface as would be presented to a user on the display 208 when the P2P communications client application 222 is open for viewing by the user. In this example, the user interface 228 is that of the P2P communications client 222 running on a first user terminal 102(A). The user interface is divided into a number of panels. A first panel 302 displays some details of the user's own profile, in this example the user's name “Joe Everyman”, an avatar image, and a “mood message”. These details may be stored at and retrieved from the P2P server 104 by the client engine 226, so as to be made available to other users of the P2P network. The avatar image is an image chosen by the user to represent themselves to other users (which need not necessarily be a photo of themselves). The mood message is a brief user-defined statement which can be used for any purpose but is typically used to express how the user is feeling, news about recent events in the user's life, or any upcoming plans that may affect the user's availability (the mood message may therefore in some cases be considered a type of presence information). When other users view Joe's profile in their own clients, these details will be visible to them via the P2P server 104, and vice versa the other users' details will be made available to Joe's client (if they are in each others' contact lists).

A second panel 304 of the user interface displays a contact list of the user's friends or associates, these being other users of the P2P network. Entry in the contact list is preferably conditional on agreement from the users. The contact list may be stored at and retrieved from the P2P server by the client engine 226, so that the same list is available to the user if the user uses different instances of the P2P communications client on different terminals. Presence information is also displayed in the panel next to each contact. The presence information represents an availability status which preferably comprises an indication of whether the user is online, and preferably is at least in part user-defined. For example, the presence status may be: the user is offline (x), the user is online and has selected to be shown as available (√), or the user is online but has selected to be shown as not available (−).

A third panel 306 of the user interface displays the profile of a selected user from the contact list, in this case “Stephen Madeup”, a user of another user terminal 102(B). The displayed profile includes Stephen's name, avatar image and mood message, along with other details Stephen may have supplied to the P2P server 104 such as current location, local time, gender and date of birth (DOB). These profile details are retrieved from the P2P server 104 by the client engine 226.

A fourth panel 308 of the user interface then displays communication controls in relation to the selected contact, such as buttons allowing a voice or video call to be established, and a window for entering chat messages. Any incoming chat messages and chat history will be displayed in this panel also, and file transfers may be established by dragging-and-dropping files into the chat window.

Most modern mobile phones (and other mobile communication devices) and personal computers support Bluetooth. One of the most common uses of Bluetooth is to pair the mobile phone with a headset for hands-free operation. Bluetooth headsets can also be paired with computers, becoming audio input/output devices. In both cases, the headset is an additional piece of hardware that enhances user experience for an end user.

However, the inventors have found that a mobile phone is a much more capable device than a simple headset, and using a mobile phone in place of a headset opens several additional possibilities for enhancing user experience of a communication system user.

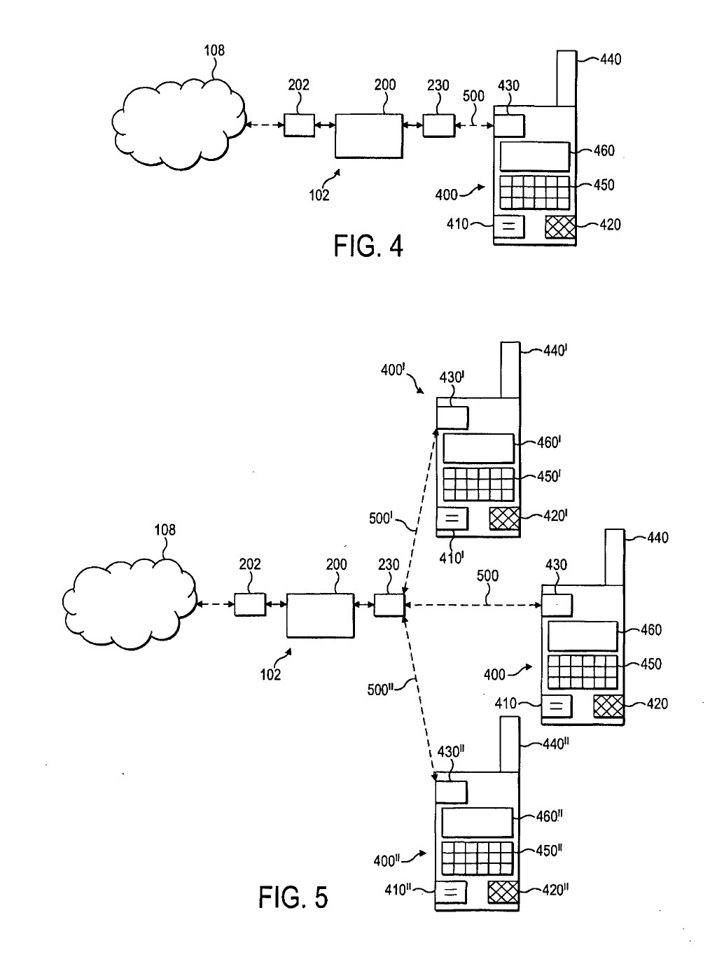

According to a first embodiment of the present invention, the user terminal 102 comprises an interface 230 for establishing a wireless connection with a mobile communication device, which in this case comprises a mobile phone 400, as illustrated in FIG. 2. In this embodiment, the interface 230 comprises a Bluetooth interface and the wireless connection comprises a Bluetooth connection. The Bluetooth connection is a direct connection between the user terminal 102 and the mobile phone 400. This connection is illustrated in FIG. 4, which shows the user terminal 102 connected by means of its network interface 202 to the Internet 108, and by means of its interface 230 to an interface 430 of the mobile phone 400 (herein after referred to as 'phone 400). The interface 430 of the mobile phone 430 is not suitable for interfacing with a node, such as a base station, of a mobile telecommunications network, in contrast to a second interface 440 (discussed below) of the mobile phone 400 that is for interfacing with a node, such as a base station, of a mobile telecommunications network. The connection 500 between the Bluetooth interface 230 of the user terminal 102 and the Bluetooth interface 430 of the 'phone 400 comprises the Bluetooth connection. With this connection in place, the 'phone 400 is said to be “paired” with the user terminal 102. Other alternative types of interface are discussed below.

The reader will understand the concept of “pairing” devices. In brief, two devices need to be paired once to communicate with each other. The pairing process is typically triggered automatically the first time a device receives a connection request from a device it is not yet paired with. Once a pairing has been established, it is remembered by the devices, which can then connect to each without user intervention. When desired, the pairing relationship can later be removed by a user. During the pairing process, the two devices involved establish a relationship by creating a shared secret known as a link key. If a link key is stored by both devices they are said to be “bonded”. A device that wants to communicate only with a bonded device can cryptographically authenticate the identity of the other device, and so be sure that it is the same device it previously paired with. Once a link key has been generated, an authenticated ACL link between the devices may be encrypted so that the data that they exchange over the airwaves is protected against eavesdropping. Link keys can be deleted at any time by either device.

Pairing of the mobile phone 400 to the user terminal 102 in some embodiments requires that either the 'phone 400 or the user terminal 102 (depending on where the pairing was initiated) shows a pin code or secret information on its display screen that has to be entered by a user into the other device being paired. If a headset was alternatively to be paired to the user terminal, a more simplified method is usually used, since headsets typically do not have sufficient buttons for entering such a pin code or secret information.

In other embodiments, no user confirmation is required to enable the pairing of the mobile communication device 400 to the user terminal 102, and in still further embodiments the user may be prompted to simply accept the pairing without entering secret information.

As will be described in more detail below, with this arrangement a user of the user terminal 102 is able to use the 'phone 400 as an audio and/or video interface device for interacting with the processor 200 of the user terminal 102. The processor 200 of the user terminal 102 is coupled to both of the interfaces 202, 230 and is configured to participate in a voice and/or video call with a second user terminal 102 via the network interface 202 and the Internet 108. Moreover, a microphone 410 of the 'phone 400 is usable by the user to send speech data to the client engine 226, and a speaker 420 of the 'phone 400 is usable by the user to hear speech generated on the basis of speech data received at the 'phone 400 from the client engine 226. In the case of a video call, a display 460 of the 'phone 400 is usable by the user to see a video generated on the basis of video data received at the 'phone 400 from the client engine 226.

When the user of the first user terminal 102 wants to establish a call with a user of the second user terminal, in some embodiments they can use the 'phone 400 to send to the user terminal 102 a request to set up the call. The request is sent via the Bluetooth connection 500 to the client engine 226, and includes an indication of an identity of the second user terminal, such as an IP address, a username in the communication system, or a telephone number (in the case where the second user terminal is connected to the Internet 108 via a PSTN network). The sending of the request can be initiated by the user operating one or more input keys 450 (such as hardware or software buttons or a scroll-wheel or other input device) of the 'phone 400. In this embodiment the user selects the intended callee from a list (such as an address book) displayed on a display 460 of the 'phone 400, and the indication in the request sent to the client engine 226 comprises an indication of the selected callee.

In some embodiments, it is possible to retrieve at the 'phone 400 from the user terminal 102 a list of contacts that are contactable via the packet-based communication network 108 using the client running on the user terminal 102. This first contact list may be merged with a second list of contacts on the 'phone 400, which comprises a list of contacts that are contactable using the 'phone 400 via the mobile telecommunications network. For each contact in the merged list, there may be provided an identifier field (in which, e.g. the name or nickname of the contact is stored), a field in which a contact address (such as an IP address) by which the contact is contactable using the packet-based communication network 108 is stored, and a field in which a contact address (such as a phone number) by which the contact is contactable using the mobile telecommunications network is stored. Other fields may also be provided for information relating to the contact, such as a postal address, an email address, an Instant Messaging ID, etc.

Thus, in such embodiments, the user of the 'phone 400 can choose which method they wish to use to contact a certain contact. A call may be selectively established at the 'phone 400 via the mobile telecommunications network, or the user may choose instead to send a request to the client engine 226 to set up a call with the contact via the packet-based communication network 108, as discussed herein.

On receiving the request to set up the call, the client engine 226 examines the request to determine the identity of the second user terminal, generates a call set-up request message, and causes the call set-up request message to be sent to the second user terminal.

Assuming the called user terminal wants to join the call, then the called user accepts the call set-up request message via the user-interface of their own client, thus generating a call accept signal. Responsive to receiving the call accept signal from the user, the client engine of the called terminal (i) generates a call set-up accept message, and (ii) instructs the voice engine of the called terminal to start transmitting/receiving speech data. The call set-up accept message is sent to the user terminal (caller) 102.

Responsive to receiving the call set-up accept message, completion of establishment of the call between the user terminal 102 and the second user terminal may be achieved as is known in the art, and so will not be further described herein.

In this embodiment, the client engine 226 causes a signal to be sent to the 'phone 400 to cause the 'phone 400 to be activated as an audio input and output (I/O) device for interaction with the processor 200 during the call with the second user terminal. More specifically, receipt of this signal at the 'phone 400 causes a processor in the 'phone 400 to activate the microphone 410 as an audio input device for the call and to activate the speaker 420 as an audio output device for the call. Moreover, the client engine 226 causes audio-routing data to be entered into memory accessible by the communications client (such as one of the RAM 206 and non-volatile memory 204), which data indicates that the 'phone 400 is an audio I/O device for the call (although the end point for the call remains the user terminal 102).

During the call, when the user of the first user terminal 102 wants to speak to a user that is using the second user terminal, they speak into the microphone 410 of the 'phone 400, and a processor in the 'phone 400 creates speech data, based on the input to the microphone 410. This speech data is then sent by the 'phone 400, via the Bluetooth connection 500, to the client engine 226. On the basis of this speech data received, the client engine 226 causes packetised speech data to be sent to the second user terminal, via the network interface 202 and the Internet 108. This sending of speech data via the network interface 202 may be achieved as is known in the art, and so will not be described any further herein.

In some embodiments the client engine 226 transfers or forwards the speech data received from the 'phone 400 to the second user terminal, i.e. the received and sent speech data has the same content. In other embodiments the client engine 226 causes some degree of processing to be performed on the received speech data before speech data is sent to the second user terminal. The speech data sent may therefore be a modified version of the speech data received. For example, during a multi-participant conference call, a conference mixer may run at the client engine 226. The client engine 226 will then combine speech received from several communication devices (of which the 'phone 400 may be one) into a single stream before encoding the stream for transmission.

Speech of the user of the second user terminal that is destined for the user of the first user terminal 102 is received at the client engine 226, via the Internet 108 and the network interface 202, as packetised speech data. On referring to the audio-routing data stored in the memory, the client engine 226 determines that the 'phone 400 comprises an audio I/O device for the call. The client engine 226 causes the speech data to be sent towards the 'phone 400, via the Bluetooth interface 230 of the user terminal 102 and the Bluetooth connection 500. The speech data sent is thus based on the speech data received.

In some embodiments the client engine 226 transfers or forwards the speech data received from the second user terminal to the 'phone 400, i.e. the received and sent speech data has the same content. In other embodiments the client engine 226 causes some degree of processing to be performed on the received speech data before speech data is sent to the 'phone 400, i.e. the speech data sent is a modified version of the speech data received. For example, during a multi-participant conference call, a conference mixer may run at the client engine 226. The client engine 226 will then send a copy of an incoming data stream to all communication devices participating in the call (of which the 'phone 400 may be one) after decoding the incoming data stream.

A processor in the 'phone 400 uses the speech data it receives from the user terminal 102 to cause the speaker 420 of the 'phone 400 to output sound representative of the speech, and the user of the 'phone 400 is then able to hear the speech from the user of the second user terminal.

During the call, the user of the 'phone 400 may decide that they wish to use the microphone 216 and speaker 214 of the personal computer to interact with the processor 200, instead of the microphone 410 and the speaker 420 of the 'phone 400. This may be because they wish to use the 'phone 400 to make a different call direct from the 'phone 400 over a mobile telecommunications network via the air interface 440 of the 'phone, or perhaps because they wish to take the 'phone 400 away from their face to view its display 460. In any case, the user can send an instruction from the 'phone 400 to the user terminal 102, for example by pressing a designated button on the 'phone 400 or by turning the 'phone off. Receipt of the instruction at the client engine 226 via the Bluetooth connection 500 causes the client engine 226 to determine that the 'phone 400 is to cease acting as the audio I/O device for interacting with the processor 200, and to instead cause the microphone 216 and speaker 214 of the user terminal 102 to act as the audio I/O devices during the call with the second user terminal.

In some embodiments, the sending of the instruction from the 'phone 400 to the user terminal 102 may be initiated by the battery of the 'phone 400 going flat or dropping below a predetermined threshold level of charge, rather than the user having to initiate the instruction-sending. In some embodiments the client engine 226 causes the microphone 216 and speaker 214 of the user terminal 102 to be activated as the audio I/O devices on receiving an instruction from another user input device of the user terminal 102, such as one of the mouse 212 or keyboard 210.

If the user wishes to use the 'phone 400 (rather than the microphone 216 and speaker 214 of the user terminal 102) for interaction with the processor 200 during a call, they may cause an instruction to be sent to the client engine 226 (from one of the 'phone 400 and a user input device of the user terminal 102, such as the mouse 212 or keyboard 210) to cause the microphone 410 and the speaker 420 of the 'phone 400 to be activated as the audio I/O devices for the call. This may be carried out regardless of whether the original request to set up the call was received at the client engine 226 from the 'phone 400, or from a user input device of the user terminal 102, i.e. regardless as to whether the 'phone 400 has previously been used for interaction with the processor 200 during the call with the second user terminal.

Whenever the device to be used as an I/O device for interaction with the processor 200 is changed, the client engine 226 in some embodiments causes the audio-routing data stored in the memory discussed above to be updated, to indicate to which device speech data is to be sent.

When the 'phone 400 is used as the audio I/O device for interaction with the processor 200 during the call with the second user terminal, the user may end the call by pressing a designated key on the 'phone 400, such as a key labelled “end call” or “hang up”, or by making some alternative input into the 'phone 400. This causes an instruction to end the call to be sent from the 'phone 400, via the Bluetooth connection 500, to the client engine 226. The call is then ended in a manner as may be known in the art.

In some embodiments, a call may be set up on the basis of a call set-up request message received at the client engine 226 from the second user terminal. On the basis of such an indication of an incoming call, the client engine 226 causes a notification signal to be sent via the Bluetooth connection 500 to the processor of the 'phone 400. This causes the processor of the 'phone 400 to provide a notification of the incoming call to the user of the 'phone 400, such as an aural and/or a visual notification. In some embodiments, the client engine 226 also causes the user terminal 102 itself to provide a notification of the incoming call, such as a visual notification on the display 208, or an aural indication via the speaker 214.

The user of the 'phone 400 may cause a signal to be sent from the 'phone 400 to the client engine 226, indicating that the user accepts the call with the second user terminal, and that the 'phone 400 is to be activated as the audio I/O device for interaction with the processor 200 during the call with the second user terminal. In some embodiments, as discussed above, the client engine 226 causes audio-routing data to be entered into memory (one of 204 and 206), which audio-routing data indicates that the 'phone 400 comprises the audio I/O device for the call with the second user terminal.

The client engine 226 causes a call set-up accept message to be sent from the first user terminal 102 to the second user terminal. Responsive to receiving the call set-up accept message, the client engine of the calling second user terminal instructs the voice engine of the second user terminal to start transmitting/receiving speech data. Establishment of the call between the user terminals is completed as may be known in the art.

A second embodiment of the present invention will now be described with reference to FIGS. 2 and 5, in which features common to the first embodiment of FIGS. 2 and 4 are referenced with the same numerals as those used in FIGS. 2 and 4. For conciseness those features will not be described again here.

In the second embodiment the user terminal 102 establishes plural respective wireless connections with mobile communication devices using the interface 230 illustrated in FIG. 2. The interface comprises a Bluetooth interface, and each mobile communication device comprises a mobile 'phone 400, 400′, 400″. Other alternative types of interface are discussed below. The user terminal 102 is connected by means of its Bluetooth interface 230 to respective Bluetooth interfaces 430, 430′, 430″ of the respective mobile 'phones 400, 400′, 400″. The connections 500, 500′, 500″ between the Bluetooth interface 230 of the user terminal 102 and the respective Bluetooth interfaces 430, 430′, 430″ of the 'phones 400, 400′, 400″ each comprise a Bluetooth connection.

In this second embodiment, call establishment may be initiated by a user operating any one of the 'phones 400, 400′, 400″ to send a request to set up a call to the client engine 226, as is described above. In addition to establishing the call with a callee that is indicated in the request by examining the request, as discussed above, the client engine 226 causes a signal to be sent to the particular 'phone 400 from which the request was received (which from hereon in will be referred to as the call-initiating 'phone 400), to cause the call-initiating 'phone 400 to be activated as an audio I/O device for interaction with the processor 200 during the call with the second user terminal. The processor 200 may also cause the other 'phones 400′, 400″ to not be activated as audio I/O devices for interaction with the processor 200 during the call. This may be because the request to set up the call received from the call-initiating 'phone 400 includes an instruction to activate only the call-initiating 'phone 400 as an audio I/O device, or because a user enters an instruction via one of the user input devices 210, 212 of the user terminal 102 to activate only the call-initiating 'phone 400 as an audio I/O device.

The client engine 226 causes audio-routing data to be entered into the memory accessible by the communications client (such as one of the RAM 206 and non-volatile memory 204), which data indicates that the call-initiating 'phone 400 comprises an audio I/O device for the call, and that the other 'phones 400′, 400″ are not audio I/O devices for the call. When speech data is received at the client engine 226 from the second user terminal during the call, as is described above, the client engine 226 refers to the audio-routing data and determines that the call-initiating 'phone 400 is an audio I/O device for the call. The client engine 226 thus causes speech data to be sent towards the call-initiating 'phone 400 via its respective Bluetooth connection 500.

In alternative embodiments, the audio-routing data may indicate that a plurality of the wirelessly-connected devices 400, 400′, 400″ are to receive the speech data, and the client engine 226 is configured during a call to send speech data towards the call-initiating 'phone 400 and also towards each of the plurality of other wirelessly-connected communication devices. In still further embodiments, the audio-routing data may indicate that all of the wirelessly-connected devices 400, 400′, 400″ are to receive the speech data.

As such, several different people could listen to received speech via speakers 420, 420′, 420″ of respective ones of the connected communication devices 400, 400′, 400″.

As discussed above, in some embodiments the client engine 226 transfers or forwards the speech data received from the second user terminal to the 'phone or 'phones. In other embodiments the client engine 226 causes some degree of processing to be performed on the received speech data before speech data is sent to the 'phone or 'phones.

Furthermore, in some embodiments, these several different people may speak into microphones 410, 410′, 410″ of their respective 'phones 400, 400′, 400″, to cause speech data to be sent to the client engine 226 via the respective Bluetooth connections 500, 500′, 500″. The client engine 226 may then be arranged to combine the speech data received from all of the 'phones 400, 400′, 400″, and send speech data to the second user terminal. In other words, in some embodiments more than one (or all) of the wirelessly-connected communication devices 400, 400′, 400″ may be activated as audio I/O devices for interaction with the processor 200 during a call.

As discussed above, in some embodiments the client engine 226 transfers or forwards the speech data received from the 'phone or 'phones to the second user terminal. In other embodiments the client engine 226 causes some degree of processing to be performed on received speech data before speech data is sent to the second user terminal.

In this second embodiment, where only one 'phone 400 of the 'phones 400, 400′, 400″ is activated as an audio I/O device for interaction with the processor 200 during the call with the second user terminal, the client engine 226 may determine that the 'phone 400 is to cease acting as the sole I/O device for interacting with the processor 200, and to as well (or instead) cause the microphone 216 and speaker 214 of the user terminal 102 to act as the audio input and output devices during the call, as described above. The instruction to change the audio input/output device may be sent from the 'phone 400 to the user terminal 102, for example by the user of the 'phone 400 pressing a designated button on the 'phone 400 or by turning the 'phone off. In some embodiments, the sending of the instruction may be initiated by the battery of the 'phone 400 going flat or dropping below a predetermined threshold level of charge, rather than the user having to initiate the sending of the instruction.

Alternatively, the client engine 226 may cause one of the other 'phones 400′, 400″ to be activated as an audio I/O device for interaction with the processor 200 during the call. The use of one of the other 'phones 400′, 400″ as an audio I/O device may be in addition to, or instead of, the use of the 'phone 400 as an audio I/O device. This changing of the audio I/O device for the call may be in dependence on receiving at the client engine 226 from the 'phone 400, via the Bluetooth connection 500, an instruction to change the audio I/O device for the call to one of the other 'phones 400′, 400″. In some embodiments, the instruction comprises an indication of which of the other 'phones 400′, 400″ is to become an audio I/O device for interaction with the processor 200 during the call. Sending of the instruction from the 'phone 400 to the user terminal 102 again may be initiated, for example, by the user of the 'phone 400 pressing a designated button on the 'phone 400 or by turning the 'phone off, or by the battery of the 'phone 400 going flat or dropping below a predetermined threshold level of charge.

In alternative embodiments, the instruction to change the audio I/O device for the call is received at the client engine 226 from the other 'phone 400′ that is to become the audio I/O device for the call. Again, the instruction may be sent for example by the user of the other 'phone 400′ pressing a designated button of the keypad 450′ of the other 'phone 400′, and the instruction may comprise an indication of the identity of the other 'phone 400′.

In alternative embodiments, an instruction to change which device(s) will comprise the audio I/O device(s) for a call is received at the client engine 226 from a user input device of the user terminal 102, such as one of the mouse 212 or keyboard 210. Again, the instruction may comprise an indication of the identity or identities of the device(s) that are to comprise the audio I/O device(s) for a call.

If the user wishes to use the 'phone 400 (rather than the microphone 216 and speaker 214 of the user terminal 102, and rather than one of the other 'phones 400′, 400″) for interaction with the processor 200 during a call (e.g. because said one of the other 'phones 400′, 400″ is to be used by a user in a separate call over a mobile telecommunications network via the air interface 440′, 440″ of that device), they may cause an instruction to be sent to the client engine 226 (from one of: the 'phone 400, the other 'phone 400′, 400″, and a user input device of the user terminal 102 such as the mouse 212 or keyboard 210) to cause the client engine 226 to cause activation of the microphone 410 and the speaker 420 of the 'phone 400 as the audio I/O devices for the call. This may be carried out regardless of whether the original request to set up the call was received at the client engine 226 from the 'phone 400, or from a user input device of the user terminal 102, i.e. regardless as to whether the 'phone 400 has previously been used for interaction with the processor 200 during the call.

Whenever the device to be used as an I/O device for interaction with the processor 200 is changed, the client engine 226 in some embodiments causes the audio-routing data stored in the memory to be updated to indicate to which device or devices the speech data is to be sent.

Ending of a call according to this second embodiment may be carried out as is described above with reference to the first embodiment.

In the second embodiment, a call may be set up on the basis of a call set up request message received at the client engine 226 from the second user terminal. On the basis of such an indication of an incoming call, the processor 200 sends a notification signal via the Bluetooth connections 500, 500′, 500″ to the processors of the respective mobile 'phones 400, 400′, 400″. This causes the 'phones 400, 400′, 400″ to provide notifications of the incoming call to the users of the 'phones 400, 400′, 400″, such as an aural and/or a visual notification. In alternative embodiments, such a notification signal may only be sent to one or some of the 'phones 400, 400′, 400″. As described above, in some embodiments the client engine 226 also causes the user terminal 102 itself to provide a notification of the incoming call, such as a visual notification on the display 208, or an aural indication via the speaker 214.

As also discussed above, the user of the 'phone 400 may cause a signal to be sent to the client engine 226 from the 'phone 400, indicating that the user accepts the call with the second user terminal, and that the 'phone 400 is to be activated as an I/O device for interaction with the processor 200 during the call with the second user terminal. The client engine 226 causes a call set-up accept message to be sent from the first user terminal 102 to the second user terminal. Responsive to receiving the call set-up accept message, the client engine of the calling second user terminal instructs the voice engine of the second user terminal to start transmitting/receiving speech data. Establishment of the call between the user terminals is completed as may be known in the art.

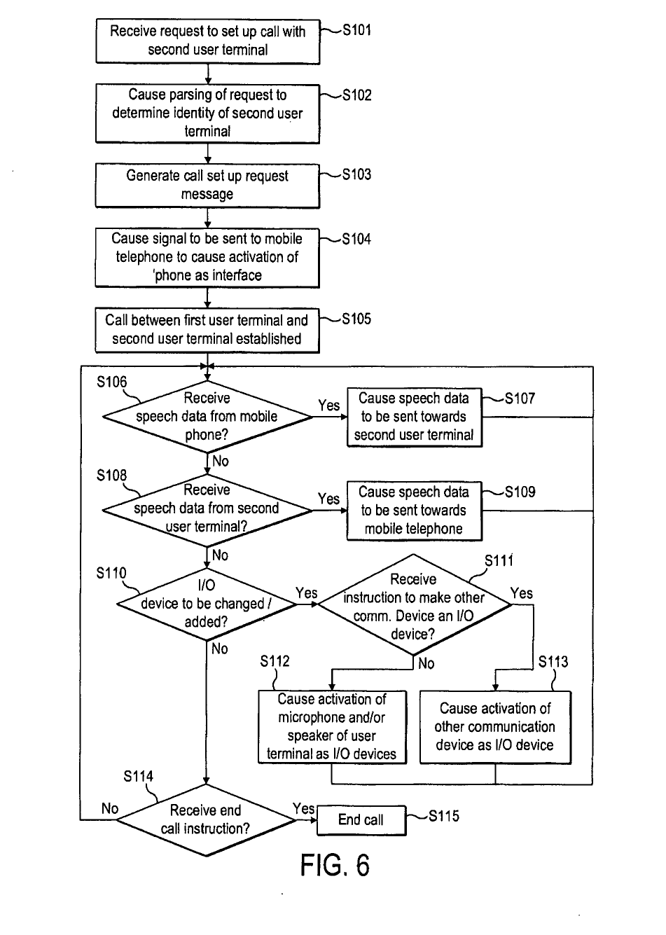

An exemplary process will now be described in relation to FIG. 6, for implementation in a client engine 226 of a processor 200 of a first user terminal 102.

At step S101, the client engine 226 of the first user terminal receives, from a mobile telephone 400 connected by Bluetooth to the first user terminal, a request to set up a call with a second user terminal.

At step S102, the client engine 226 causes the received request to be analysed to determine an identity of the second user terminal.

At step S103, the client engine 226 generates a call set-up request message, and the message is sent to the second user terminal via the network 108. In preferred embodiments this is by P2P connection set-up. The first user terminal will preferably be the host for the call, although that need not necessarily be the case.

At step S104, the client engine 226 causes a signal to be sent to the 'phone 400 via the Bluetooth connection, to cause activation of the 'phone 400 as an audio I/O device for interaction with the processor 200 during the call. In some embodiments, this step may precede or happen at the same time as step S103. In some embodiments, it is necessary for the user of the 'phone 400 to cause the 'phone 400 to send a signal to the client engine 226, to cause this activation. In some embodiments, the client engine 226 also causes audio-routing data to be entered into memory (one of 204 and 206), which audio-routing data indicates that the 'phone 400 comprises an audio I/O device for the call.

Assuming the called user terminal wants to join the call, then the called user accepts the call set-up request message via the user-interface of their own client, thus generating a call accept signal. Responsive to receiving the call accept signal from the user, the client engine of the called terminal (i) generates a call set-up accept message, and (ii) instructs the voice engine of the called terminal to start transmitting/receiving speech data. The call set-up accept message is sent to the first user terminal (caller).

At step S105, responsive to receiving the call set-up accept message at the client engine 226, establishment of the call between the user terminals is completed as may be known in the art. The client engine 226 of the first user terminal then instructs the voice engine of the first user terminal to start transmitting/receiving speech data.

At step S106, a determination is made at the client engine 226 as to whether it has received speech data from the 'phone 400. If it has, then at step S107 the client engine 226 causes speech data to be sent to the second user terminal, and the process then returns to step S106. If it has not, then the process moves on to step S108.

At step S108, a determination is made at the client engine 226 as to whether it has received speech data from the second user terminal. If it has, then at step S109 the client engine 226 causes speech data to be sent to the 'phone 400 via the Bluetooth connection 500, optionally after consulting the audio-routing information stored in the memory to determine to which device the information is to be sent. The process then returns to step S106. If it has not, then the process moves on to step S110.

At step S110, a determination is made at the client engine 226 as to whether it has received an indication, such as an instruction from the 'phone 400, that there is to be a modification relating to which of the device(s) is to act as the audio I/O device(s) for interaction with the processor 200 for the call. If so, then at step S111 a determination is made at the client engine 226 as to whether it has received an instruction to cause another communication device (such as an alternative 'phone 400′, 400″) connected to the first user terminal via a Bluetooth connection to become an audio I/O device. If not, then at step S112 the client engine 226 causes the microphone 216 and/or speaker 214 of the first user terminal to act as the audio I/O devices for the call, and the process then returns to step S106. Alternatively, if the answer at step s111 is “yes”, then at step S113 the client engine 226 causes the other communication device to be activated as an audio I/O device for interaction with the processor 200 during the call. This may be achieved by the client engine 226 sending a signal to the other communication device via its Bluetooth connection. The process then returns to step S106.

If at step S110 it is not determined that the audio I/O device(s) for the call is to be so modified, then the process proceeds to step S114, at which a determination is made as to whether the client engine 226 has received an instruction (or request) to end the call (from the 'phone 400, another user input device 210, 212 of the user terminal 102, or optionally from the second user terminal). If so, then at step S115 the call is ended as may be known in the art. If not, then the process returns to step S106.

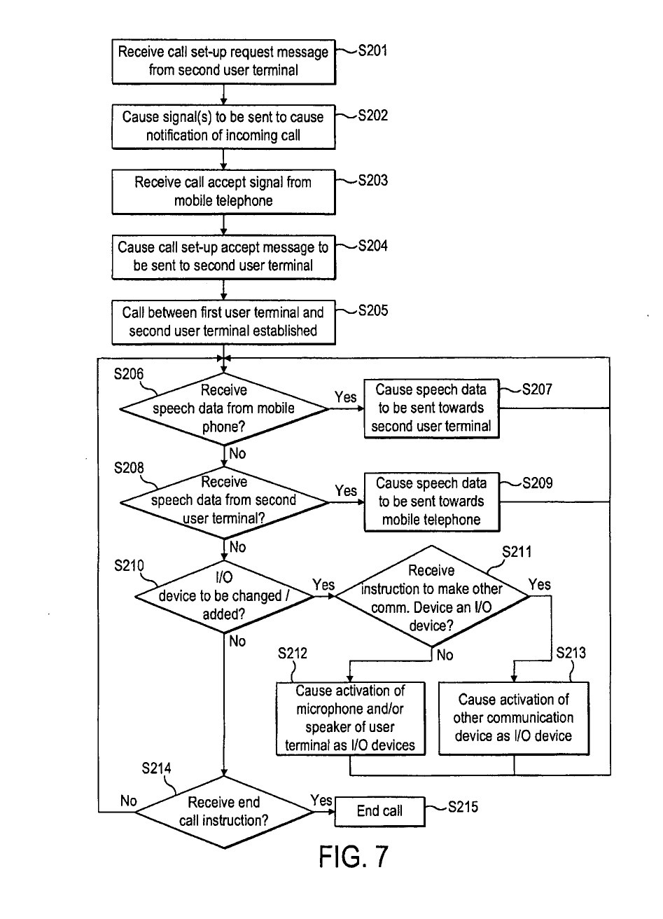

Another exemplary process will now be described in relation to FIG. 7, for implementation in a client engine 226 of a processor 200 of a first user terminal 102.

At step S201, the client engine 226 of the first user terminal receives, from a second user terminal, an indication of an incoming call in the form of a call set-up request message. In preferred embodiments this is by P2P connection set-up.

At step S202, the client engine 226 causes a notification signal to be sent from the first user terminal 102 to the 'phone 400 connected to the user terminal 102 via the Bluetooth connection 500. This notification signal is indicative of the incoming call, and causes the processor of the 'phone 400 to provide a notification of the incoming call to the user of the 'phone 400. In some embodiments, such a notification signal is also sent to one or more other communication devices 400′, 400″ (such as an alternative 'phones 400′, 400″) connected by way of respective Bluetooth connections 500′, 500″ to the user terminal 102, to cause those one or more other communication devices 400′, 400″ to also provide a notification of the incoming call to a user. In some embodiments, the client engine 226 causes the user terminal 102 itself to provide notification of the incoming call to a user, by way of the display 208 and/or the speaker 214 of the user terminal 102.

At step S203, the client engine 226 receives from the 'phone 400 a signal indicating that the user wishes to use the 'phone 400 for the call with the second user terminal. This signal indicates that the user accepts the call and that the 'phone 400 is to be activated as an audio I/O device for interaction with the processor 200 during the call. In some embodiments, the client engine 226 causes audio-routing data to be entered into memory (one of 204 and 206), which audio-routing data indicates that the 'phone 400 comprises an audio I/O device for the call.

At step S204, the client engine 226 causes a call set-up accept message to be sent from the first user terminal 102 to the second user terminal. Responsive to receiving the call set-up accept message, the client engine of the calling second user terminal instructs the voice engine of the second user terminal to start transmitting/receiving speech data.

At step S205, the call establishment between the user terminals is completed as may be known in the art. The second user terminal will preferably be the host for the call, although that need not necessarily be the case. The client engine 226 of the first user terminal instructs the voice engine of the first user terminal 102 to start transmitting/receiving speech data.

Steps S206 to S215 are the same as steps S106 to S115, respectively, discussed above with reference to FIG. 6. Therefore, for conciseness these steps will not be repeated here.

Although the above has been described mainly in terms of a peer-to-peer (P2P) system, the present invention is not specific to P2P and may be applied to any kind of packet-based communications system, such as more the centralised VoIP systems mentioned previously. Further, the present invention is not limited to use over the Internet, but could be implemented over any packet-based network.

Although reference has been made above to wireless connections comprising Bluetooth connections, in other embodiments a WiFi connection, wireless USB connections, or other types of wireless connections may alternatively be employed. Although the wireless connections 500, 500′, 500″ described above with reference to the second embodiment all comprise the same type of wireless connection, in other embodiments two or more of the wireless connections 500, 500′, 500″ may be of different types, such as WiFi and/or wireless USB.

In the above described embodiments, the user terminal 102 is connected to the mobile phone 400 by way of a wireless connection. In other embodiments, a wired connection, such as a USB connection, may instead be provided between the user terminal 102 and the mobile phone 400. Similarly, a wired connection may be provided between the user terminal 102 and one, some or each of the other communication devices 400′, 400″.

The user terminal 102 may therefore be wirelessly connected to some mobile communication devices and may be connected by means of wired connections to other mobile communication devices.

It will be understood that many types of communication interface support more than one device on one interface. Thus, in the above-described second embodiment, a single Bluetooth interface of the user terminal 102 is used for establishing respective wireless connections with several mobile communication devices 400, 400′, 400″. This is possible because Bluetooth supports more than once device in parallel via a single Bluetooth interface, as each Bluetooth interface has three voice channels and two data channels that paired devices can share. Similarly, in other embodiments, one WiFi, Ethernet, or other LAN technology interface of the user terminal 102 may be used for establishing the respective connections with several mobile communication devices 400, 400′, 400″.

In other embodiments, such as where the means for connecting between the user terminal 102 and mobile communication devices 400, 400′, 400″ is by way of a Universal Serial Bus (USB) interface, separate respective interfaces may be required and provided between the user terminal 102 and each connected mobile communication device 400, 400′, 400″. However, alternatively, a USB hub can be used to hook many communication devices to the user terminal via a single USB interface of the user terminal 102.

In the above described embodiments, the mobile communication device 400 comprises a cellular mobile phone. In other embodiments, the mobile communication device 400 instead comprises one of: a non-cellular mobile phone, a smart phone, a laptop, and a netbook, or any other device comprising an interface with a mobile telecommunications network as well as a different interface for communicating with the user terminal 102.

In addition to 'phone 400, the other communication devices 400′, 400″ described above are also, by example, cellular mobile telephones. In alternative embodiments, each of the respective other communication devices may comprise one of a wired headset or handset, a wireless headset or handset, a television set, a call recording device, and one of the alternative mobile communication devices discussed in the preceding paragraph. Although two communication devices 400′, 400″ are discussed above in addition to the 'phone 400, of course alternatively there may be at least one other communication device wirelessly connected to the user terminal in addition to the 'phone 400.

Although the calls described above with reference to the first and second embodiments comprise voice calls, the calls may additionally or alternatively comprise video calls, i.e. calls in which video created by a user of the mobile 'phone 400 and/or a user of the called user terminal is exchanged between the user terminals. In that case, the speech data exchanged between the user terminals during the call may be replaced by, or supplemented with, video data. Thus, call data exchanged between the user terminals may comprise one or both of video data and speech data. In such cases, video-routing data may be entered into memory and later consulted in a similar manner to the audio-routing data discussed above. In some embodiments, data may be entered into memory and later consulted for routing any call data that is received during a call to specified device(s). Moreover, setting of a device as a video I/O device may also be enacted in a similar manner to the above-described setting of a device as an audio I/O device.

The call may additionally or alternatively comprise exchange of call data defining instant messaging message(s).

Use of a mobile phone as a mobile communication device 400 connected to the user terminal 102 provides further advantages over the alternative use of a simple audio headset. User interface and user interaction possibilities are a main difference. A mobile phone, as opposed to a simple audio headset, can be used to initiate calls and manipulate existing calls. For example, a mobile phone has its own address book. The mobile phone 400 can be used to cause calls with contacts listed in that address book to be established via the user terminal 102 and the packet-based communication network 108 directly from the mobile phone 400. If for some reason the user terminal 102 is not available (for example if the mobile phone 400 is out of range for communication with the user terminal 102) then calling via the mobile telecommunications network is then still possible using the mobile phone 400.

In addition, in contrast to the use of an audio headset, textual and graphical content can be delivered to the mobile phone 400 from the user terminal 102. For example, the user terminal 102 may send information, such as a caller's name, nickname and/or avatar image, to the mobile phone 400 when notifying the mobile phone 400 that there is an incoming call, and this information may then be displayed on the display 460 of the mobile phone 400.

While the user terminal is described above by example as comprising a personal computer, the user terminal may alternatively or additionally comprise a dedicated base station to which the mobile telephone (and optionally other communication device(s)) is connected. In some embodiments, the user terminal may not comprise one or more of the speaker 214, microphone 216, webcam 218, display 208, keyboard 210 and mouse 212 discussed above. Thus, in some embodiments, the only audio I/O device for interaction with the user terminal's processor during a call may comprise the mobile communication device that is connected to the user terminal via the interface 230.

In preferred embodiments, the processes discussed above are implemented by software stored on a general purpose memory such as flash memory or hard drive and executed on a general purpose processor, the software preferably but not necessarily being integrated as part of the communications client. However, alternatively the processes could be implemented as separate application(s), or in firmware, or even in dedicated hardware.

Reference is made herein to “calls”. It is to be noted that calls are distinguished from other connections within which data is exchanged between nodes, since data (i.e. call data, such as speech or voice data, or video data) exchanged between entities during a call comprises real-time data.

Other configurations and applications of the present invention may be apparent to the person skilled in the art given the disclosure herein. The scope of the invention is not limited by the described embodiments, but only by the appended claims.

What is claimed is:

1. A method of communicating using a user terminal that comprises:
a first interface for exchanging call data with a first interface of a mobile communication device, wherein the mobile communication device comprises a second interface for interfacing with a node of a mobile telecommunications network, and wherein the first interface of the mobile communication device is unsuitable for interfacing with a node of a mobile telecommunications network;
a second interface for exchanging call data with a second user terminal over a packet-based communication network; and
a processor for executing a communications client, which processor is coupled to the first interface of the user terminal and to the second interface of the user terminal and is configured to participate in a call with the second user terminal via the second interface of the user terminal and the packet-based communication network;
wherein the method comprises:
sending call data via one of the first interface of the user terminal and the second interface of the user terminal during the call, on the basis of call data received via the other of the first interface of the user terminal and the second interface of the user terminal.

2. The method of claim 1, comprising sending to the second user terminal a request to set up the call, in dependence on receiving from the mobile communication device a request to set up the call.

3. The method of claim 2, wherein the request to set up the call from the mobile communication device comprises an indication of an identity of the second user terminal.

4. The method of claim 1, comprising sending a signal to the mobile communication device, to cause the mobile communication device to be activated as an input/output device for interaction with the processor during the call.

5. The method of claim 4, wherein the user terminal comprises a personal computer having a microphone and a speaker; and
wherein the method comprises causing activation of the microphone and the speaker as audio input/output devices for interaction with the processor during the call, in dependence on a determination that the mobile communication device is to cease acting as an input/output device for interaction with the processor.

6. The method of claim 5, wherein the determination comprises one of a determination that the mobile communication device has been switched off and a determination that a battery of the mobile communication device has dropped below a threshold level of charge.

7. The method of claim 5, comprising causing the activation of the microphone and the speaker, in dependence on receiving an instruction to cause the activation of the microphone and the speaker.

8. The method of claim 7, comprising receiving the instruction from the mobile communication device.

9. The method of claim 1, comprising sending a notification signal to the mobile communication device to cause the mobile communication device to provide to a user a notification of an incoming call, in dependence on receiving an indication of the incoming call via the first interface.

10. The method of claim 9, wherein the notification signal comprises an indication of an identity of the second user terminal.

11. The method of claim 9, wherein the user terminal comprises a personal computer, and wherein the method comprises causing the personal computer to also provide to a user a notification of the incoming call.

12. The method of claim 1, wherein the user terminal comprises at least one interface for communication with at least one other communication device.

13. The method of claim 12, comprising causing one of the at least one other communication devices to be activated as an input/output device for interaction with the processor during the call, in dependence on receiving an instruction to make said one of the at least one other communication devices an input/output device for the call.

14. The method of claim 13, comprising receiving the instruction from the mobile communication device.

15. The method of claim 12, comprising sending a respective notification signal to each of the at least one other communication devices to cause each of the at least one other communication devices to provide a notification to a user of an incoming call, in dependence on receiving an indication of the incoming call via the first interface.

16. The method of claim 12 comprising sending call data to the mobile communication device and each of the at least one other communication devices during the call with the second user terminal.

17. The method of claim 12, comprising causing the mobile communication device to be activated as an input/output device for interaction with the processor during the call and causing the at least one other communication device to not be activated as an input/output device for interaction with the processor during the call, in dependence on receiving an instruction to cause the mobile communication device to be activated as an input/output device for interaction with the processor.

18. The method of claim 17, comprising receiving the instruction from the mobile communication device.

19. The method of claim 1, wherein the first user terminal is connected to the mobile communication device via a Bluetooth connection.

20. The method of claim 1, wherein the packet-based communication network comprises the internet and the communications client comprises one or both of a voice over internet protocol client and a video over internet protocol client.

21. A computer program product for communicating using a user terminal, the program comprising code embodied on a computer-readable medium arranged so as, when executed on a processor, to implement a method as in claim 1.

22. A user terminal, comprising:
a first interface for exchanging call data with a first interface of a mobile communication device, wherein the mobile communication device comprises a second interface for interfacing with a node of a mobile telecommunications network, and wherein the first interface of the mobile communication device is unsuitable for interfacing with a node of a mobile telecommunications network;
a second interface for exchanging call data with a second user terminal over a packet-based communication network; and
a processor for executing a communications client, which processor is coupled to the first interface of the user terminal and to the second interface of the user terminal and is configured to participate in a call with the second user terminal via the second interface of the user terminal and the packet-based communication network;
wherein the processor is configured, during the call, to send call data via one of the first interface of the user terminal and the second interface of the user terminal, on the basis of call data received via the other of the first interface of the user terminal and the second interface of the user terminal.

23. A method of communicating using a mobile communication device that comprises:
a first interface for exchanging call data with a user terminal connected to a packet-based communication network during a call, which first interface is unsuitable for interfacing with a node of a mobile telecommunications network;
a second interface for interfacing with a node of a mobile telecommunications network;
a microphone for receiving sound;
a speaker for outputting sound; and
a processor coupled to the first interface, to the microphone and to the speaker;
wherein the method comprises:
the processor sending call data via the first interface during the call, on the basis of sound received at the microphone; and
the processor causing sound to be output from the speaker during the call, on the basis of call data received via the first interface.

24. A computer program product for communicating using a mobile communication device, the program comprising code embodied on a computer-readable medium arranged so as, when executed on a processor, to implement a method as in claim 23.

25. A mobile communication device, comprising:
a first interface for exchanging call data with a user terminal connected to a packet-based communication network during a call, which first interface is unsuitable for interfacing with a node of a mobile telecommunications network;
a second interface for interfacing with a node of a mobile telecommunications network;
a microphone for receiving sound;
a speaker for outputting sound; and
a processor coupled to the first interface, to the microphone and to the speaker;
wherein the processor is configured, during the call, to send call data via the first interface, on the basis of sound received at the microphone, and to cause sound to be output from the speaker, on the basis of call data received via the first interface.
